(19) United States
(12) Patent Application Publication
(10) Pub. No.: US 2024/0315486 A1
(43) Pub. Date: Sep. 26, 2024

(54) WIND GUARD OF GRIDDLE AND WINDPROOF STRUCTURE OF GRIDDLE

(71) Applicant: Chun HONG, Shenzhen (CN)

(72) Inventor: Chun HONG, Shenzhen (CN)

(21) Appl. No.: 18/661,645

(22) Filed: May 12, 2024

(30) Foreign Application Priority Data
Apr. 16, 2024 (CN) 202420788337.2

(51) Int. Cl. A47J 37/07; A47J 37/06

(52) U.S. Cl. CPC A47J 37/0786; A47J 37/067

(57) ABSTRACT

The present disclosure discloses a wind guard of a griddle, including a main wind guard, wherein the main wind guard is provided with a magnetic member; the magnetic member is configured to be magnetically sucked on a baking tray or a seat body to enable an upper part of the main wind guard to cover the baking tray and enable a lower part of the main wind guard to cover the seat body; the main wind guard is provided with an air inlet; the air inlet penetrates through a first side surface and a second side surface of the main wind guard; the air inlet is arranged between upper part of the main wind guard and the lower part of the main wind guard to stagger the baking tray from the seat body.

### TECHNICAL FIELD

The present disclosure relates to the field of griddles, and in particular, to a wind guard of a griddle and a windproof structure of a griddle.

### BACKGROUND

With the improvement of the living standard, people often hold a barbecue party, go camping, go on a picnic, and hold other party activities in leisure time. In these activities, a griddle is used. In the prior art, the griddle generally includes a seat body and a baking tray. A burner is arranged on the seat body; the baking tray is arranged above the burner to form a combustion space between the baking tray and the seat body; and an air inlet gap is formed at an edge of the combustion space, so that air can enter the combustion space through the air inlet gap, and the griddle can operate normally. However, during the operation of the griddle with the above structure, if there is a breeze or a rapid air flow, the following situations easily occur: burning flames cannot be concentrated, the combustion is insufficient, and the like, thereby affecting the use effect of the griddle. Especially when the griddle is used outdoors, the above situations are particularly prominent.

### SUMMARY

In order to overcome the shortcomings in the prior art, the present disclosure provides a wind guard of a griddle and a windproof structure of a griddle.

The technical solution used in the present disclosure to solve the technical problems is as follows:

The present disclosure provides a wind guard of a griddle, including a main wind guard, wherein the main wind guard is provided with a magnetic member; the magnetic member is configured to be magnetically sucked on a baking tray or a seat body to enable an upper part of the main wind guard to cover the baking tray and enable a lower part of the main wind guard to cover the seat body; the main wind guard is provided with an air inlet; the air inlet penetrates through a first side surface and a second side surface of the main wind guard; the air inlet is arranged between upper part of the main wind guard and the lower part of the main wind guard to stagger the baking tray from the seat body; the main wind guard is provided with a secondary wind guard; the secondary wind guard covers the air inlet on the first side surface of the main wind guard; a first air inlet gap is formed between the secondary wind guard and the first side surface of the main wind guard; and the air inlet gap is communicated with the air inlet.

A lower side edge of the secondary wind guard is connected to a lower side edge of the air inlet; the secondary wind guard extends upwards from the lower side edge of the air inlet; and an upper side edge of the secondary wind guard is flush with or protrudes out of an upper side edge of the air inlet to form the first air inlet gap between the upper side edge of the air inlet and the first side surface of the main wind guard.

A left side edge of the secondary wind guard is connected to a left side edge of the air inlet, and a right side edge of the secondary wind guard is connected to a right side edge of the air inlet.

A joint between the lower side edge of the secondary wind guard and the lower side edge of the air inlet is arranged in a manner of arc-shaped flow guide; a joint between the left side edge of the secondary wind guard and the left side edge of the air inlet is arranged in a manner of arc-shaped flow guide; and a joint between the right side edge of the secondary wind guard and the right side edge of the air inlet is arranged in a manner of arc-shaped flow guide.

The secondary wind guard is integrally formed with the main wind guard.

A surface of the main wind guard and a surface of the secondary wind guard are each coated with a protective layer.

The second side surface of the main wind guard is provided with a mounting side plate protruding out of the second side surface, and the magnetic member is arranged on the mounting side plate.

A surface of the mounting side plate is recessed to form a mounting countersink; the magnetic member is arranged in the mounting countersink; and the magnetic member docs not protrude out of the surface of the mounting side plate.

The main wind guard and the mounting side plate are arranged in an L shape.

The magnetic member is a high-temperature-resistant magnet.

There are at least two mounting side plates; and every two mounting side plates are arranged on the second side surface of the main wind guard at an interval.

A reinforcing rib is arranged between every two mounting side plates.

The mounting side plate is integrally formed with the main wind guard.

The surface of the mounting side plate is coated with a protective layer.

The present disclosure further provides a windproof structure of a griddle, comprising a baking tray, a seat body, and the wind guard of the griddle as described above, wherein a burner is arranged on the seat body; the baking tray is arranged above the burner to form a combustion space between the baking tray and the seat body; a second air inlet gap is formed at an edge of the combustion space; the main wind guard is magnetically sucked to the baking tray or the seat body by the magnetic member of the main wind guard; the upper part of the main wind guard covers the baking tray, and the lower part of the main wind guard covers the seat body, so that the main wind guard covers the second air inlet gap; and the first air inlet gap, the air inlet, and the second air inlet gap are communicated to each other in sequence.

A corner support is arranged at an end portion of the second air inlet gap; the corner support extends towards the second air inlet gap to form a corner wind guard; and when the main wind guard covers the second air inlet gap, an end portion of the main wind guard is arranged on an inner side of the corner wind guard.

The corner support is arranged on the seat body.

A supporting column is arranged between the baking tray and the seat body; the supporting column is arranged in the second air inlet gap; and the mounting side plate of the wind guard is staggered from the supporting column.

The supporting column is integrally formed with the seat body or the baking tray.

The present disclosure has the beneficial effects: By the above structural arrangement, during use, the wind guard can be magnetically sucked to the baking tray or the seat body through the magnetic member, so that the upper part of the main wind guard covers the baking tray and the lower part of the main wind guard covers the seat body, thereby covering the second air inlet gap by the main wind guard and forming the structure in which the first air inlet gap, the air inlet, and the second air inlet gap are communicated to each other in sequence. 1. By means of the magnetic suction fixing, the wind guard can be fixed to the baking tray or the seat body, so that it is very convenient to remove and mount. 2. The main wind guard effectively covers the second air inlet gap. During use of the griddle, even in strong wind, an air flow can be prevented from flowing into the combustion space via the second air inlet gap, so as to achieve effective a wind shielding effect of the wind guard. 3. Based on effective wind shielding, the air inlet and the secondary wind guard are added on the wind guard. The secondary wind guard covers the air inlet at the first side surface of the main wind guard, and the first air inlet gap is formed between the secondary wind guard and the first side surface of the main wind guard, so that air required by combustion can enter the combustion space via the first air inlet gap, the air inlet, and the second air inlet gap to ensure full combustion of fuel gas and effectively save the fuel gas. Furthermore, in the above structure, an air inlet path is more tortuous. Even in case of a rapid air flow, the rapid air flow can be buffered to ensure that the rapid air flow cannot rapidly flow into the combustion space, thereby ensuring the combustion effect.

In conclusion, according to the wind guard of the griddle of this patent, due to the structural design of two wind guards, an effective wind shielding effect is achieved, thereby ensuring full combustion, concentrated burning flames, and other effects, and effectively improving the use effect of the griddle.

### BRIEF DESCRIPTION OF THE DRAWINGS

For clearer descriptions of the technical solutions according to the embodiments of the present disclosure, the drawings required to be used in the description of the embodiments are briefly introduced below. The drawings in the description below are only some embodiments of the present disclosure, and those skilled in the art that other drawings can be acquired according to the drawings without creative efforts.

The present disclosure will be further explained below in conjunction with the accompanying drawings and embodiments.

FIG. 1 is a schematic structural diagram of a griddle, wherein a wind guard is magnetically sucked to a seat body;

FIG. 2 is a schematic structural diagram of a griddle, wherein a baking tray is provided with a baking tray cover;

FIG. 3 is a schematic exploded diagram of FIG. 1, wherein the baking tray is exploded;

FIG. 4 is a schematic exploded diagram of FIG. 1, wherein the wind guard is exploded;

FIG. 5 is an enlarged view of the part A in FIG. 4;

FIG. 6 is a cross-sectional view of a griddle longitudinally cut away along an air inlet of a wind guard, wherein the wind guard is magnetically sucked on a seat body;

FIG. 7 is an enlarged view of the part B in FIG. 6;

FIG. 8 is a cross-sectional view of a griddle longitudinally cut away along a magnetic member of a wind guard, wherein the wind guard is magnetically sucked on a seat body;

FIG. 9 is an enlarged view of the part C in FIG. 8;

FIG. 10 is a schematic structural diagram of a wind guard in one angle;

FIG. 11 is a schematic structural diagram of a wind guard in another angle;

FIG. 12 is a cross-sectional view of a wind guard longitudinally cut away along an air inlet;

FIG. 13 is a schematic structural diagram of a griddle, wherein a wind guard is magnetically sucked to a baking tray;

FIG. 14 is a schematic exploded diagram of FIG. 13, wherein the wind guard is exploded; and

FIG. 15 is an enlarged view of the part D in FIG. 14.

### DETAILED DESCRIPTION OF THE EMBODIMENTS

### Embodiment I

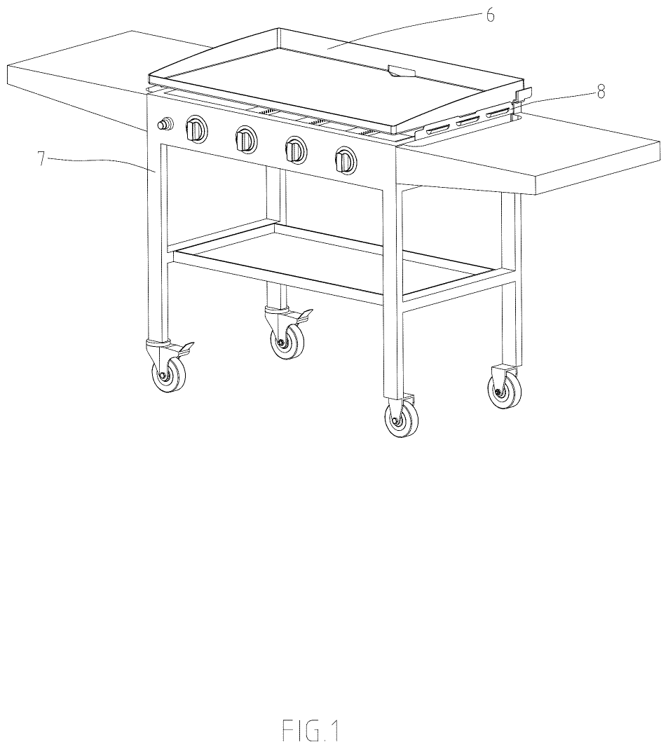

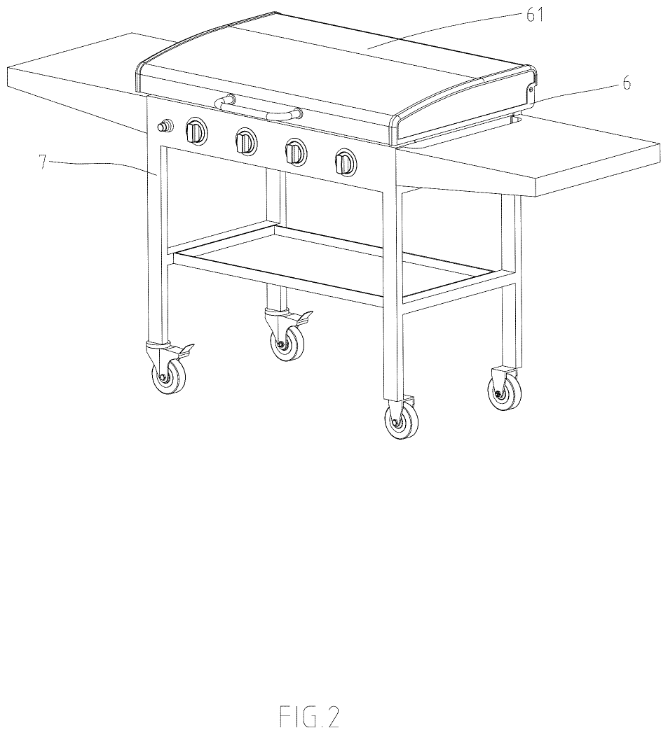

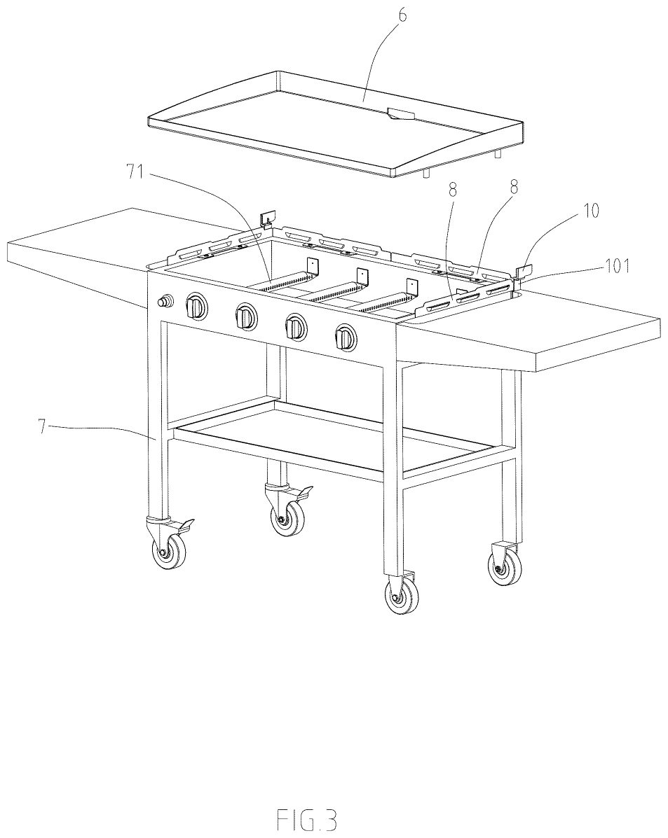

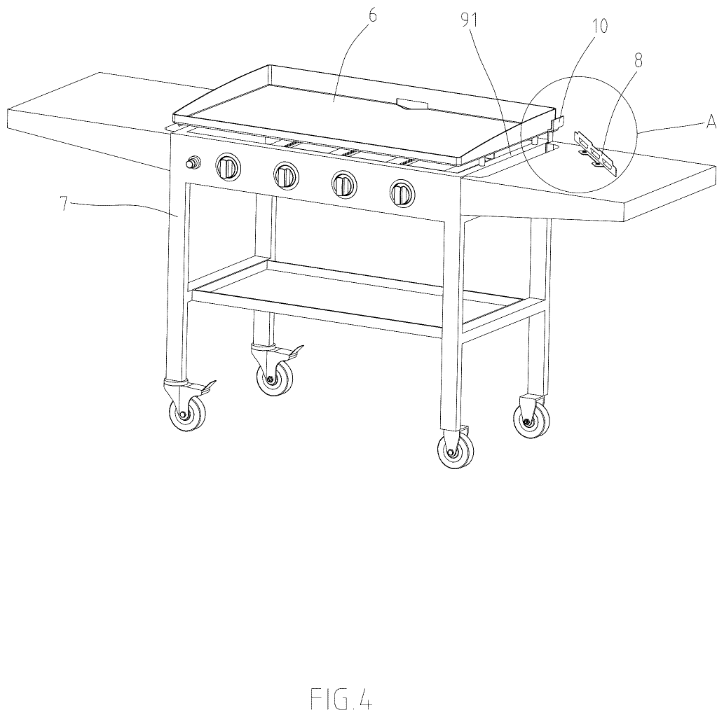

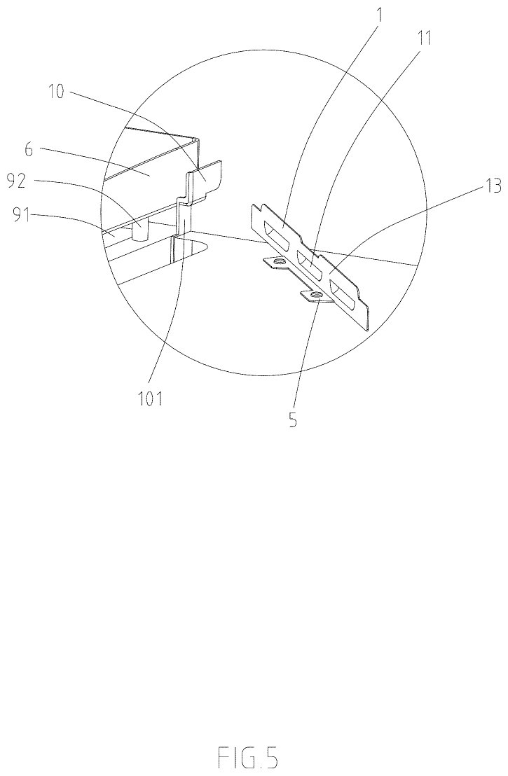

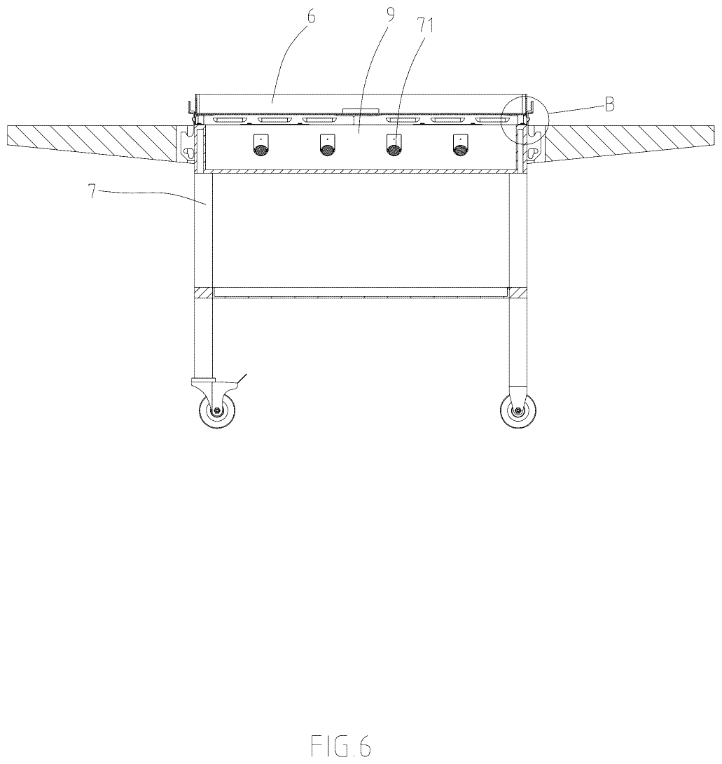

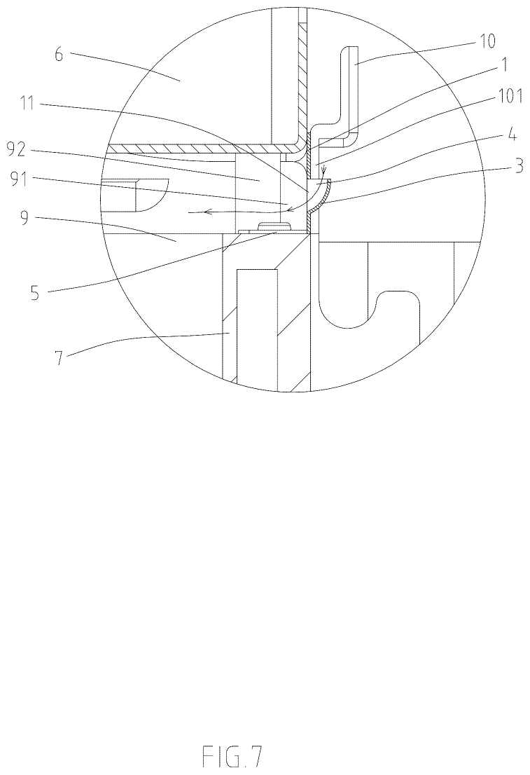

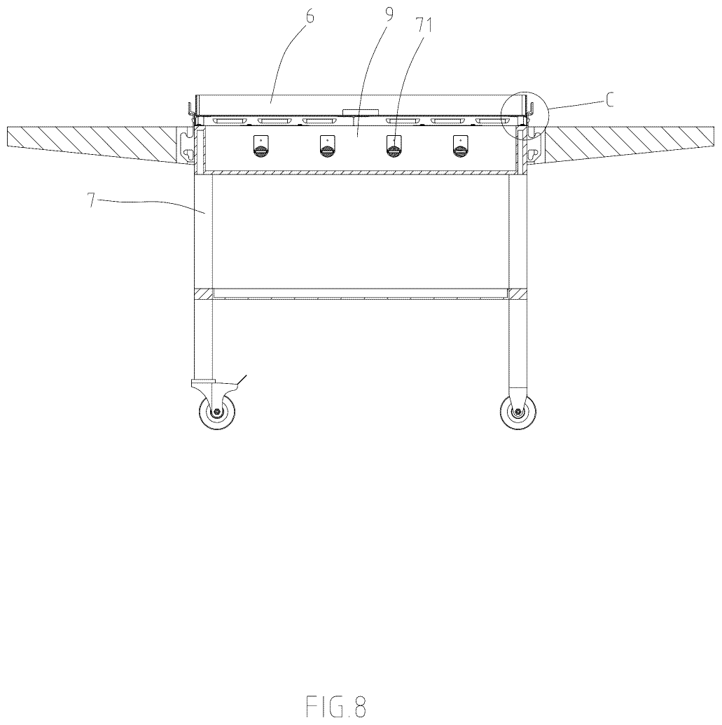

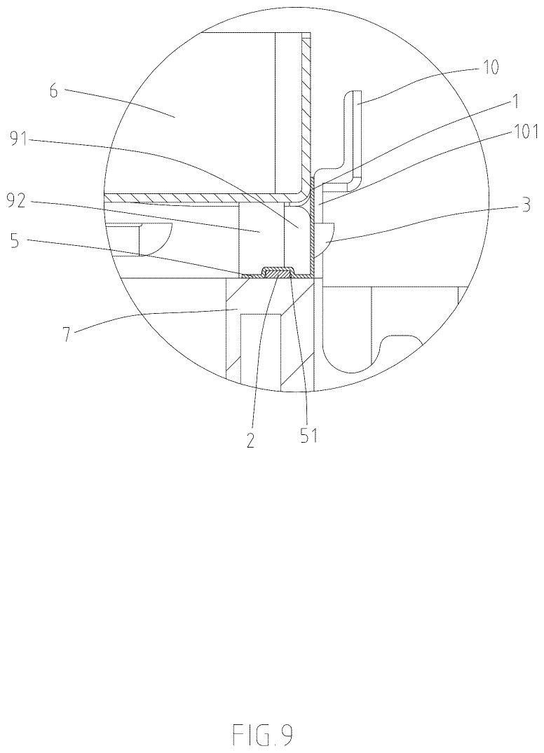

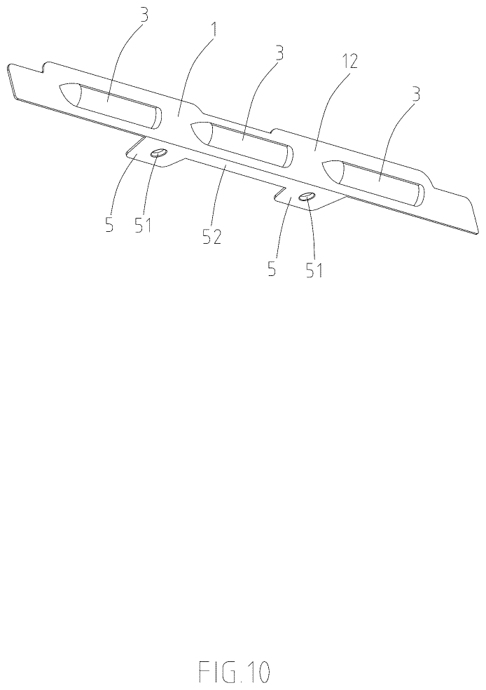

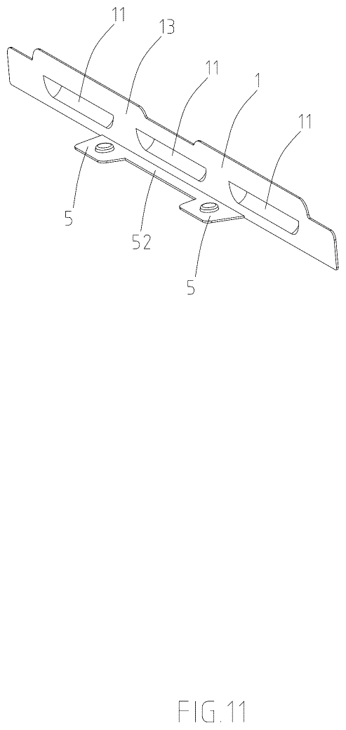

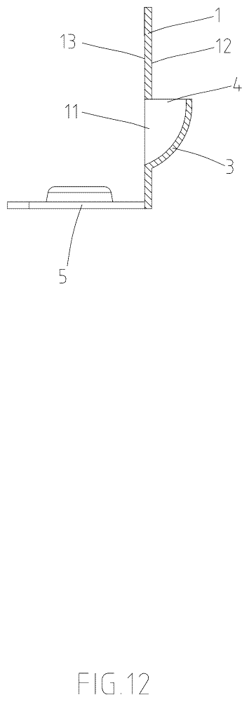

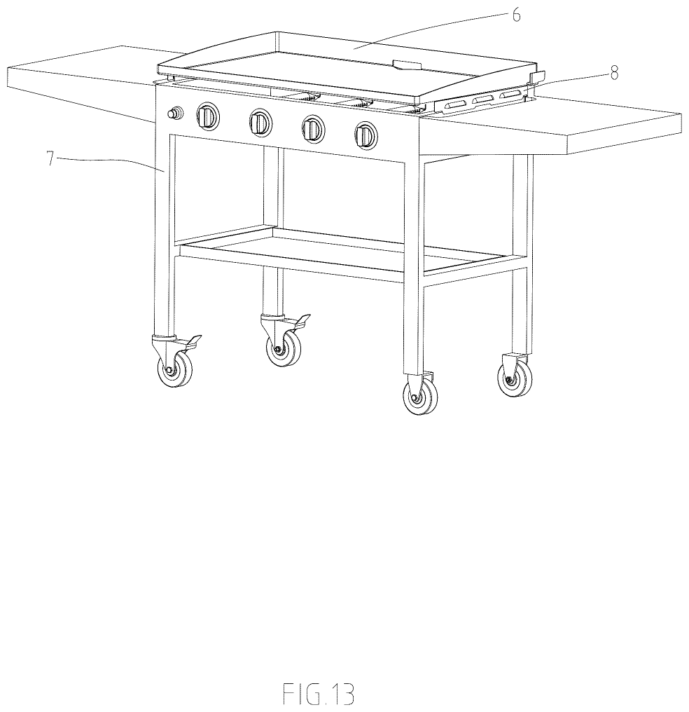

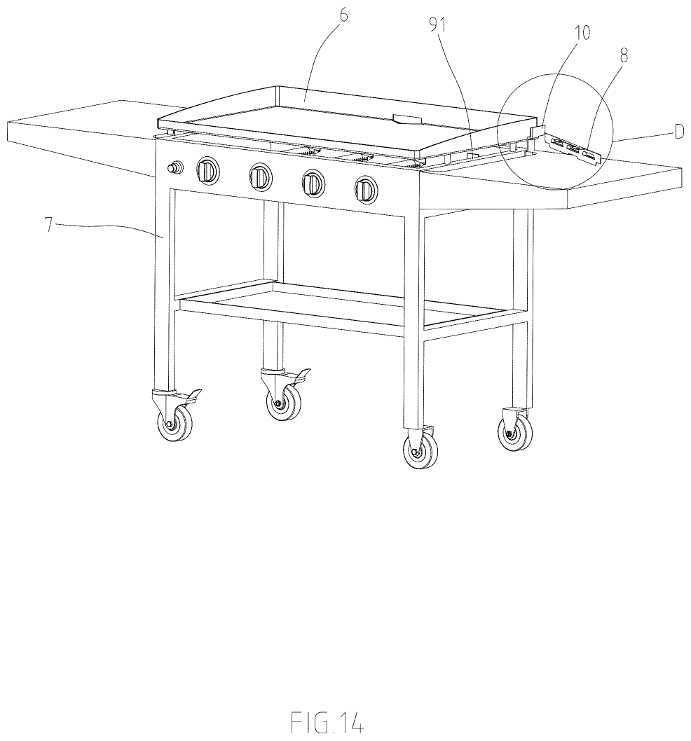

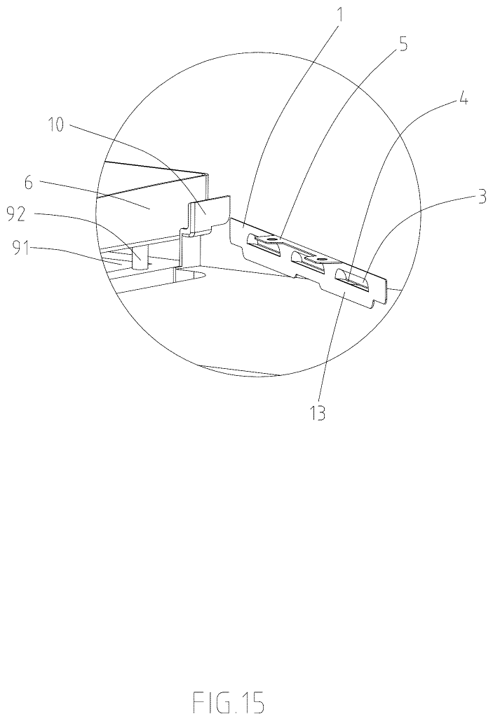

Referring to FIG. 1 to FIG. 15, a wind guard of a griddle includes a main wind guard 1, wherein the main wind guard 1 is provided with a magnetic member 2; the magnetic member 2 is configured to be magnetically sucked on a baking tray or a seat body to enable an upper part of the main wind guard 1 to cover the baking tray and enable a lower part of the main wind guard 1 to cover the seat body; the main wind guard 1 is provided with an air inlet 11; the air inlet 11 penetrates through a first side surface 12 and a second side surface 13 of the main wind guard 1; the air inlet 11 is arranged between upper part of the main wind guard 1 and the lower part of the main wind guard 1 to stagger the baking tray from the seat body; the main wind guard 1 is provided with a secondary wind guard 3; the secondary wind guard 1 covers the air inlet 11 on the first side surface 12 of the main wind guard 1; a first air inlet gap 4 is formed between the secondary wind guard 3 and the first side surface 12 of the main wind guard 1; and the air inlet gap 4 is communicated with the air inlet 11. The number of the air inlet is not limited, which may be one, two, three, or the like, as long as normal air intake can be achieved. Correspondingly, the secondary wind guard is determined according to the number of the air inlet. For example, if there are three air inlets, there are three secondary wind guards.

By the above structural arrangement, during use, the wind guard can be magnetically sucked to the baking tray or the seat body through the magnetic member, so that the upper part of the main wind guard covers the baking tray and the lower part of the main wind guard covers the seat body, thereby covering the second air inlet gap by the main wind guard and forming the structure in which the first air inlet gap, the air inlet, and the second air inlet gap are communicated to each other in sequence. 1. By means of the magnetic suction fixing, the wind guard can be fixed to the baking tray or the seat body, so that it is very convenient to remove and mount. 2. The main wind guard effectively covers the second air inlet gap. During use of the griddle, even in strong wind, an air flow can be prevented from flowing into the combustion space via the second air inlet gap, so as to achieve effective a wind shielding effect of the wind guard. 3. Based on effective wind shielding, the air inlet and the secondary wind guard are added on the wind guard. The secondary wind guard covers the air inlet at the first side surface of the main wind guard, and the first air inlet gap is formed between the secondary wind guard and the first side surface of the main wind guard, so that air required by combustion can enter the combustion space via the first air inlet gap, the air inlet, and the second air inlet gap to ensure full combustion of fuel gas and effectively save the fuel gas. Furthermore, in the above structure, an air inlet path is more tortuous. Even in case of a rapid air flow, the rapid air flow can be buffered to ensure that the rapid air flow cannot rapidly flow into the combustion space, thereby ensuring the combustion effect.

In conclusion, according to the wind guard of the griddle of this patent, due to the structural design of two wind guards, an effective wind shielding effect is achieved, thereby ensuring full combustion, concentrated burning flames, and other effects, and effectively improving the use effect of the griddle.

In this embodiment, a lower side edge of the secondary wind guard 3 is connected to a lower side edge of the air inlet 11; the secondary wind guard 3 extends upwards from the lower side edge of the air inlet 11; and an upper side edge of the secondary wind guard 3 is flush with or protrudes out of an upper side edge of the air inlet 11 to form the first air inlet gap 4 between the upper side edge of the air inlet 11 and the first side surface 12 of the main wind guard 1. By the above structural arrangement, the secondary wind guard has a better wind shielding effect. Of course, the upper side and the lower side are only opposite to each other. In this patent, it can also be that an upper side edge of the secondary wind guard is connected to an upper side edge of the air inlet 11; the secondary wind guard 3 extends upwards from the upper side edge of the air inlet 11; and a lower side edge of the secondary wind guard 3 is flush with or protrudes out of a lower side edge of the air inlet 11 to form the first air inlet gap 4 between the lower side edge of the air inlet 11 and the first side surface 12 of the main wind guard 1.

A left side edge of the secondary wind guard 3 is connected to a left side edge of the air inlet 11, and a right side edge of the secondary wind guard 3 is connected to a right side edge of the air inlet 11. Further, a joint between the lower side edge of the secondary wind guard 3 and the lower side edge of the air inlet 11 is arranged in a manner of arc-shaped flow guide; a joint between the left side edge of the secondary wind guard 3 and the left side edge of the air inlet 11 is arranged in a manner of arc-shaped flow guide; and a joint between the right side edge of the secondary wind guard 3 and the right side edge of the air inlet 11 is arranged in a manner of arc-shaped flow guide. By the above structural arrangement, when air flows into the griddle, the air can be effectively guided due to the arc-shaped flow guide. For example, the inflow air can be guided into the middle of the combustion space. This is more conductive for diffusion of the air in the combustion space, so that the combustion is full.

In this embodiment, the second side surface 13 of the main wind guard 1 is provided with a mounting side plate 5 protruding out of the second side surface 13, and the magnetic member 2 is arranged on the mounting side plate 5. The main wind guard 1 and the mounting side plate 5 are arranged in an L shape. During mounting, the main wind guard covers the second air inlet gap by its second side surface. The mounting side plate can be inserted into the second air inlet gap and is magnetically sucked on the baking tray or the seat body through the magnetic member, so that the structure is simple, and the removal and mounting are convenient.

In this embodiment, the secondary wind guard 3 is integrally formed with the main wind guard 1, and the mounting side plate 5 is integrally formed with the main wind guard 1. The main wind guard, the secondary wind guard, and the mounting side plate are all metal materials, and can be integrally formed, so that the structure is simple, and the production is convenient.

In this embodiment, a surface of the main wind guard and a surface of the secondary wind guard are each coated with a protective layer. A surface of the mounting side plate 5 is coated with a protective layer. It is conductive to protecting the product, for example, preventing the product from being scratched. The protective layer is not shown in the drawings.

Furthermore, a surface of the mounting side plate 5 is recessed to form a mounting countersink 51; the magnetic member 2 is arranged in the mounting countersink 51; and the magnetic member 2 does not protrude out of the surface of the mounting side plate 5. Thus, the surface of the mounting side plate is flat. This is conductive to mounting the mounting side plate. The magnetic member2 is a high-temperature-resistant magnet to ensure the magnetic suction function of the magnetic member.

Further, there are at least two mounting side plates 5; and every two mounting side plates 5 are arranged on the second side surface 13 of the main wind guard 1 at an interval. A reinforcing rib 52 is arranged between every two mounting side plates 5. By the above structural arrangement, the wind guard is mounted more stably, and the structure of the wind guard is also stable. Of course, there may be two, three, four, or more mounting side plates, as long as it meets a mounting requirement.

### Embodiment II

Referring to FIG. 1 to FIG. 15, a windproof structure of a griddle, including a baking tray 6, a seat body 7, and the wind guard 8 of the griddle as described in Embodiment I, wherein a burner 71 is arranged on the seat body 7; the baking tray 6 is arranged above the burner 71 to form a combustion space 9 between the baking tray 6 and the seat body 7; a second air inlet gap 91 is formed at an edge of the combustion space 9; the main wind guard 1 is magnetically sucked to the baking tray 6 or the seat body 7 by the magnetic member 2 of the main wind guard 1; the upper part of the main wind guard 1 covers the baking tray 6, and the lower part of the main wind guard 1 covers the seat body 7, so that the main wind guard 1 covers the second air inlet gap 91, and the first air inlet gap 4, the air inlet 11, and the second air inlet gap 91 are communicated to each other in sequence. A baking tray cover 61 can be covered at the baking tray.

By the above structural arrangement, during use, the wind guard can be magnetically sucked to the baking tray or the seat body through the magnetic member, so that the upper part of the main wind guard covers the baking tray and the lower part of the main wind guard covers the seat body, thereby covering the second air inlet gap by the main wind guard and forming the structure in which the first air inlet gap, the air inlet, and the second air inlet gap are communicated to each other in sequence. 1. By means of the magnetic suction fixing, the wind guard can be fixed to the baking tray or the seat body, so that it is very convenient to remove and mount. 2. The main wind guard effectively covers the second air inlet gap. During use of the griddle, even in strong wind, an air flow can be prevented from flowing into the combustion space via the second air inlet gap, so as to achieve effective a wind shielding effect of the wind guard. 3. Based on effective wind shielding, the air inlet and the secondary wind guard are added on the wind guard. The secondary wind guard covers the air inlet at the first side surface of the main wind guard, and the first air inlet gap is formed between the secondary wind guard and the first side surface of the main wind guard, so that air required by combustion can enter the combustion space via the first air inlet gap, the air inlet, and the second air inlet gap to ensure full combustion of fuel gas and effectively save the fuel gas. Furthermore, in the above structure, an air inlet path is more tortuous. Even in case of a rapid air flow, the rapid air flow can be buffered to ensure that the rapid air flow cannot rapidly flow into the combustion space, thereby ensuring the combustion effect.

In conclusion, according to the windproof structure of the griddle of this patent, due to the structural design of two wind guards, an effective wind shielding effect is achieved, thereby ensuring full combustion, concentrated burning flames, and other effects, and effectively improving the use effect of the griddle.

In this embodiment, a corner support 10 is arranged at an end portion of the second air inlet gap 91; the corner support 10 extends towards the second air inlet gap 91 to form a corner wind guard 101; and when the main wind guard 1 covers the second air inlet gap 91, an end portion of the main wind guard 1 is arranged on an inner side of the corner wind guard 101. In the griddle, different side surfaces of the griddle (such as a front surface, a side surface, and a back surface of the griddle) have the second air inlet gaps, and an end portion of the second air inlet gap is a corner of the griddle. Therefore, when the wind guard is spliced at the corner, an end portion of the main wind guard in the wind guard can be placed on the inner side of the corner wind guard, thereby effectively avoiding the problem of a poor wind shielding effect caused by splicing gaps between the wind guards. The structure is simple and the design is reasonable. Furthermore, the arrangement of the corner support is further convenient for the mounting of the wind guard. The corner support 10 is arranged on the seat body 7.

In this embodiment, a supporting column 92 is arranged between the baking tray 6 and the seat body 7; the supporting column 92 is arranged in the second air inlet gap 91; and the mounting side plate 5 of the wind guard 8 is staggered from the supporting column 92. The structure is simple, and the assembling is facilitated. The supporting column 92 is integrally formed with the seat body 7 or the baking tray 6.

The above shows one or more implementations provided in combination with specific contents, and it is not deemed that the specific implementations of the present disclosure is limited to these explanations. Any technical inferences or replacements that are similar or identical to the method and structure of the present disclosure or made under the idea of the present disclosure shall fall within the protection scope of the present disclosure.

1. A wind guard of a griddle, comprising a main wind guard (1), wherein the main wind guard (1) is provided with a magnetic member (2); the magnetic member (2) is configured to be magnetically sucked on a baking tray or a seat body to enable an upper part of the main wind guard (1) to cover the baking tray and enable a lower part of the main wind guard (1) to cover the seat body; the main wind guard (1) is provided with an air inlet (11); the air inlet (11) penetrates through a first side surface (12) and a second side surface (13) of the main wind guard (1); the air inlet (11) is arranged between upper part of the main wind guard (1) and the lower part of the main wind guard (1) to stagger the baking tray from the seat body; the main wind guard (1) is provided with a secondary wind guard (3); the secondary wind guard (3) covers the air inlet (11) on the first side surface (12) of the main wind guard (1); a first air inlet gap (4) is formed between the secondary wind guard (3) and the first side surface (12) of the main wind guard (1); and the air inlet gap (4) is communicated with the air inlet (11).

2. The wind guard of the griddle according to claim 1, wherein a lower side edge of the secondary wind guard (3) is connected to a lower side edge of the air inlet (11); the secondary wind guard (3) extends upwards from the lower side edge of the air inlet (11); and an upper side edge of the secondary wind guard (3) is flush with or protrudes out of an upper side edge of the air inlet (11) to form the first air inlet gap (4) between the upper side edge of the air inlet (11) and the first side surface (12) of the main wind guard (1).

3. The wind guard of the griddle according to claim 2, wherein a left side edge of the secondary wind guard (3) is connected to a left side edge of the air inlet (11), and a right side edge of the secondary wind guard (3) is connected to a right side edge of the air inlet (11).

4. The wind guard of the griddle according to claim 3, wherein a joint between the lower side edge of the secondary wind guard (3) and the lower side edge of the air inlet (11) is arranged in a manner of arc-shaped flow guide; a joint between the left side edge of the secondary wind guard (3) and the left side edge of the air inlet (11) is arranged in a manner of arc-shaped flow guide; and a joint between the right side edge of the secondary wind guard (3) and the right side edge of the air inlet (11) is arranged in a manner of arc-shaped flow guide.

5. The wind guard of the griddle according to claim 4, wherein the secondary wind guard (3) is integrally formed with the main wind guard (1).

6. The wind guard of the griddle according to claim 4, wherein a surface of the main wind guard (1) and a surface of the secondary wind guard (3) are each coated with a protective layer.

7. The wind guard of the griddle according to claim 2, wherein the second side surface (13) of the main wind guard (1) is provided with a mounting side plate (5) protruding out of the second side surface (13), and the magnetic member (2) is arranged on the mounting side plate (5).

8. The wind guard of the griddle according to claim 7, wherein a surface of the mounting side plate (5) is recessed to form a mounting countersink (51); the magnetic member (2) is arranged in the mounting countersink (51); and the magnetic member (2) does not protrude out of the surface of the mounting side plate (5).

9. The wind guard of the griddle according to claim 8, wherein the main wind guard (1) and the mounting side plate (5) are arranged in an L shape.

10. The wind guard of the griddle according to claim 8, wherein the magnetic member (2) is a high-temperature-resistant magnet.

11. The wind guard of the griddle according to claim 8, wherein there are at least two mounting side plates (5); and every two mounting side plates (5) are arranged on the second side surface (13) of the main wind guard (1) at an interval.

12. The wind guard of the griddle according to claim 11, wherein a reinforcing rib (52) is arranged between every two mounting side plates (5).

13. The wind guard of the griddle according to claim 8, wherein the mounting side plate (5) is integrally formed with the main wind guard (1).

14. The wind guard of the griddle according to claim 8, wherein the surface of the mounting side plate (5) is coated with a protective layer.

15. A windproof structure of a griddle, comprising a baking tray (6), a seat body (7), and the wind guard (8) of the griddle according to claim 1, wherein a burner (71) is arranged on the seat body (7); the baking tray (6) is arranged above the burner (71) to form a combustion space (9) between the baking tray (6) and the seat body (7); a second air inlet gap (91) is formed at an edge of the combustion space (9); the main wind guard (1) is magnetically sucked to the baking tray (6) or the seat body (7) by the magnetic member (2) of the main wind guard (1); the upper part of the main wind guard (1) covers the baking tray (6), and the lower part of the main wind guard (1) covers the seat body (7), so that the main wind guard (1) covers the second air inlet gap (91); and the first air inlet gap (4), the air inlet (11), and the second air inlet gap (91) are communicated to each other in sequence.

16. The windproof structure of the griddle according to claim 15, wherein a corner support (10) is arranged at an end portion of the second air inlet gap (91); the corner support (10) extends towards the second air inlet gap (91) to form a corner wind guard (101); and when the main wind guard (1) covers the second air inlet gap (91), an end portion of the main wind guard (1) is arranged on an inner side of the corner wind guard (101).

17. The windproof structure of the griddle according to claim 16, wherein the corner support (10) is arranged on the seat body (7).

18. The windproof structure of the griddle according to claim 15, wherein a supporting column (92) is arranged between the baking tray (6) and the seat body (7); the supporting column (92) is arranged in the second air inlet gap (91); and the mounting side plate (5) of the wind guard (8) is staggered from the supporting column (92).

19. The windproof structure of the griddle according to claim 18, wherein the supporting column (92) is integrally formed with the seat body (7) or the baking tray (6).
